(19) United States
(12) Patent Application Publication
(10) Pub. No.: US 2014/0102106 A1
(43) Pub. Date: Apr. 17, 2014

(54) Combustor Bulkhead Cooling Array

(71) Applicant: UNITED TECHNOLOGIES CORPORATION, Hartford, CT (US)

(72) Inventors: Timothy S. Snyder, Glastonbury, CT (US); John S. Tu, West Hartford, CT (US)

(73) Assignee: UNITED TECHNOLOGIES CORPORATION, Hartford, CT (US)

(21) Appl. No.: 13/649,581

(22) Filed: Oct. 11, 2012

(51) Int. Cl. F02C 1/00

(52) U.S. Cl. 60/752

(57) ABSTRACT

A bulkhead panel is disclosed. The bulkhead panel may comprise a body having a body having a front surface and an opposite back surface, a fuel nozzle opening in the body and communicating through the front and back surfaces, and a plurality of effusion holes disposed in at least one row that surrounds and is generally concentric to the fuel nozzle opening. Each effusion hole may extend from the back surface to the front surface at an incline angle. Each effusion hole may be positioned at a clock angle from a reference line radially extending from a center of the fuel nozzle opening through a center of the effusion hole.

### FIELD OF THE DISCLOSURE

The present disclosure relates generally to gas turbine engines and, more particularly, to combustors of a gas turbine engine.

### BACKGROUND OF THE DISCLOSURE

Gas turbine engines typically include a compressor, a combustor, and a turbine, with an annular flow path extending axially through each. Initially, air flows through the compressor where it is compressed or pressurized. The combustor then mixes and ignites the compressed air with fuel, generating hot combustion gases. These hot combustion gases are then directed by the combustor to the turbine where power is extracted from the hot gases by causing blades of the turbine to rotate.

The combustor is typically comprised of spaced apart inner and outer liners, which define a combustion chamber. At the upstream end of the combustion chamber is a bulkhead. The bulkhead includes a plurality of openings to accommodate fuel nozzles, which project into the forward end of the combustion chamber to supply fuel.

Due to the introduction of fuel and recirculation of the combustion products, the bulkhead is subject to extremely high temperatures. As a result, damage to the bulkhead may occur from exposure to hot combustion gases. Accordingly, there exists a need to provide the bulkhead with effective cooling without negatively impacting ignition, low power performance, emission and operability.

### SUMMARY OF THE DISCLOSURE

According to one embodiment of the present disclosure, a bulkhead panel is disclosed. The bulkhead panel may comprise a body having a front surface and an opposite back surface, a fuel nozzle opening in the body and communicating through the front and back surfaces, and a plurality of effusion holes disposed in at least one row that surrounds and is generally concentric to the fuel nozzle opening. Each effusion hole may extend from the back surface to the front surface at an incline angle. Each effusion hole may be positioned at a clock angle from a reference line radially extending from a center of the fuel nozzle opening through a center of the effusion hole.

In a refinement, the clock angle may be at least in part aligned with a swirling component of a fuel nozzle flow.

In another refinement, the incline angle may be at least in part aligned with a downstream component of a fuel nozzle flow.

In another refinement, the at least one row may comprise a first row surrounding the fuel nozzle opening and a second row surrounding the first row.

In a related refinement, the first and second rows may have a same number of effusion holes, the effusion holes may be equally spaced apart within each respective row, and wherein the effusion holes of the second row may be circumferentially offset from the effusion holes of the first row.

In another refinement, the incline angle may be between an inclusive range of 20 to 35 degrees from the back surface to the front surface.

In another refinement, the incline angle may be 25 degrees from the back surface to the front surface.

In another refinement, the clock angle may be between an inclusive range of 30 to 60 degrees from the reference line.

In another refinement, the clock angle may be 45 degrees from the reference line.

In another refinement, each effusion hole may have a diameter between an inclusive range of 0.02 to 0.03 inches.

In another refinement, the at least one row may have a diameter between a range having a lower limit of a fuel nozzle opening diameter (Df) and an inclusive upper limit of the fuel nozzle opening diameter plus 1.5 inches (Df+1.5 inches).

In yet another refinement, the at least one row may have a number of effusion holes between an inclusive range of 8 to 48 effusion holes.

According to another embodiment, a gas turbine engine is disclosed. The gas turbine engine may comprise a compressor section, a turbine section, and a combustor. The combustor may have an inner liner and an outer liner defining a combustion chamber, and a bulkhead heat shield at one end of the combustion chamber. The bulkhead heat shield may have a plurality of panels. Each panel may have a body having a front surface and an opposite back surface, a fuel nozzle opening in the body and communicating through the front and back surfaces, and at least one row of effusion holes that surrounds and is generally concentric to the fuel nozzle opening. Each of the effusion holes may extend from the back surface to the front surface at an incline angle and may be positioned at a clock angle from a reference line radially extending from a center of the fuel nozzle opening through a center of the effusion hole.

In a refinement, the at least one row of effusion holes may comprise a first row surrounding the fuel nozzle opening and a second row surrounding the first row.

In another refinement, the first and second rows may have a same number of effusion holes, the effusion holes may be equally spaced apart within each respective row, and wherein the effusion holes of the second row may be circumferentially offset from the effusion holes of the first row.

In another refinement, the clock angle may be at least in part aligned with a swirling component of a fuel nozzle flow.

In yet another refinement, the incline angle may be at least in part aligned with a downstream component of a fuel nozzle flow.

According to yet another embodiment, a combustor for a gas turbine engine is disclosed. The combustor may comprise an inner liner and an outer liner defining a combustion chamber, and a bulkhead heat shield at one end of the combustion chamber. The bulkhead heat shield may be have of a plurality of panels. Each panel may have a body having a front surface and an opposite back surface, a fuel nozzle opening in the body and communicating through the front and back surfaces, and at least one row of effusion holes that surrounds and is generally concentric to the fuel nozzle opening. Each of the effusion holes may extend from the back surface to the front surface at a first angle. Each effusion hole may be positioned at a clock angle from a reference line radially extending from a center of the fuel nozzle opening through a center of the effusion hole.

In a refinement, the at least one row of effusion holes may comprise a first row of effusion holes surrounding the fuel nozzle opening and a second row of effusion holes surrounding the first row, the first and second rows may have a same number effusion holes equally spaced apart within each respective row, and wherein the effusion holes of the second row may be circumferentially offset from the effusion holes of the first row.

In another refinement, the clock angle may orient a flow out of the effusion hole in a radially inward direction.

These and other aspects and features of the disclosure will become more readily apparent upon reading the following detailed description when taken in conjunction with the accompanying drawings.

### BRIEF DESCRIPTION OF THE DRAWINGS

FIG. 1 is a schematic cross-sectional view of a gas turbine engine according to one embodiment of the present disclosure;

FIG. 2 is a cross-sectional view of part of a combustor of the gas turbine engine of FIG. 1;

FIG. 3 is a perspective view of a heat shield of the combustor of FIG. 2;

FIG. 4 is an enlarged view of a portion of the combustor of FIG. 2;

FIG. 5 is a front view of a panel of the heat shield of FIG. 3;

FIG. 6 is a cross-sectional view of the heat shield panel of FIG. 5; and

FIG. 7 is an enlarged view of a portion of the head shield panel of FIG. 5

While the present disclosure is susceptible to various modifications and alternative constructions (i.e. maybe a manufacturing or repair technic), certain illustrative embodiments thereof, will be shown and described below in detail. It should be understood, however, that there is no intention to be limited to the specific embodiments disclosed, but on the contrary, the intention is to cover all modifications, alternative constructions, and equivalents along within the spirit and scope of the present disclosure.

### DETAILED DESCRIPTION

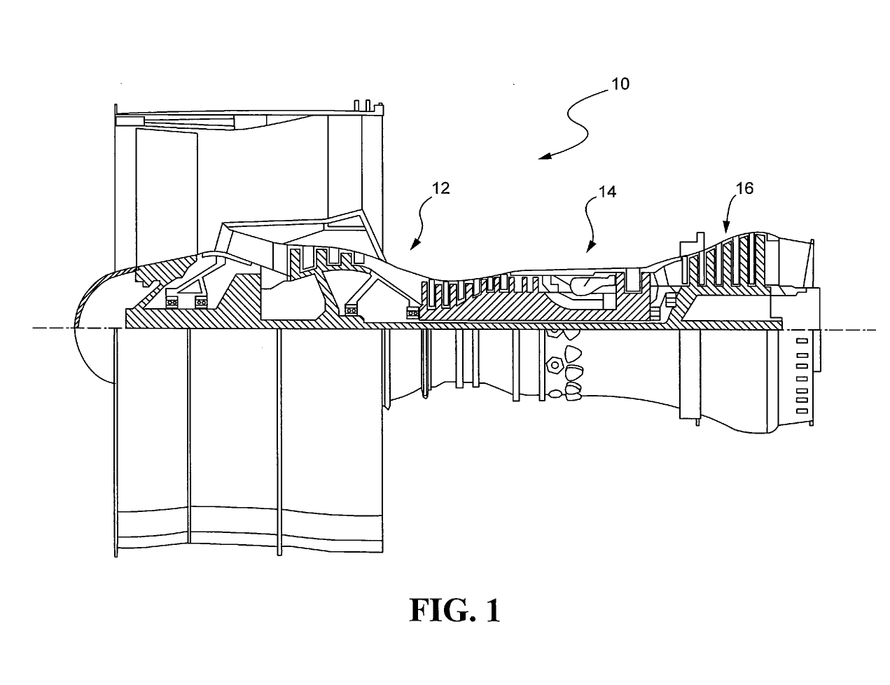

Referring now to the drawings, and with specific reference to FIG. 1, in accordance with the teachings of the disclosure, an exemplary gas turbine engine 10 is shown. The gas turbine engine 10 may generally comprise a compressor section 12 where air is pressurized, a combustor 14 which mixes and ignites the compressed air with fuel generating hot combustion gases, a turbine section 16 for extracting power from the hot combustion gases, and an annular flow path extending axially through each. It will be understood that the combustor 14 as disclosed herein is not limited to the depicted embodiment of the gas turbine engine 10 but may be applicable to other types of gas turbine engines.

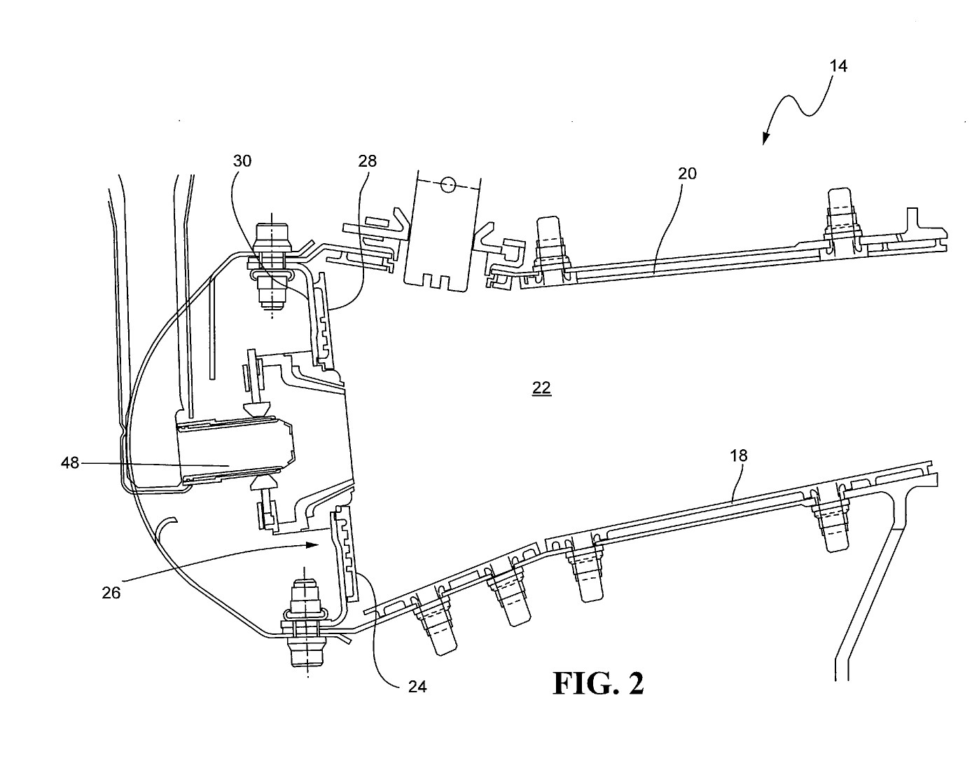

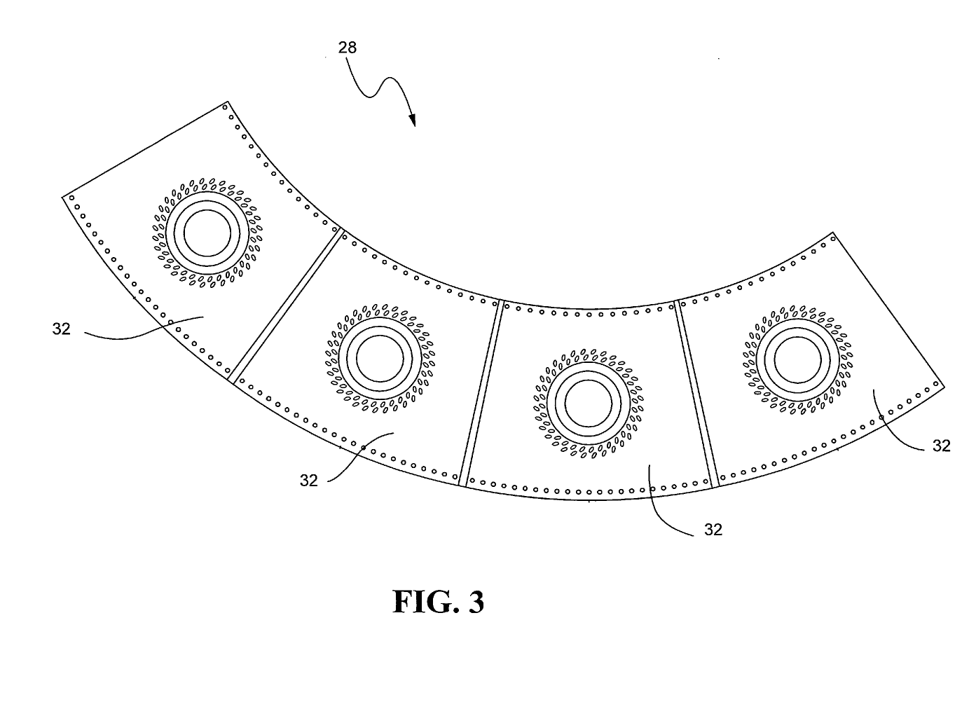

Referring now to FIG. 2, an exemplary cross-sectional view of part of a combustor 14 of the gas turbine engine 10 is shown. The combustor 14 may comprise an inner liner 18 and an outer liner 20, which define a combustion chamber 22. At an upstream end 24 of the combustion chamber 22 may be a bulkhead assembly 26. The bulkhead assembly may comprise a bulkhead heat shield 28 mounted to a bulkhead shell 30. The heat shield 28 may be spaced apart from the shell 30 such that there is a distance between the heat shield 28 and shell 30. As shown best in FIG. 3, the heat shield 28 may be comprised of a plurality of panels 32.

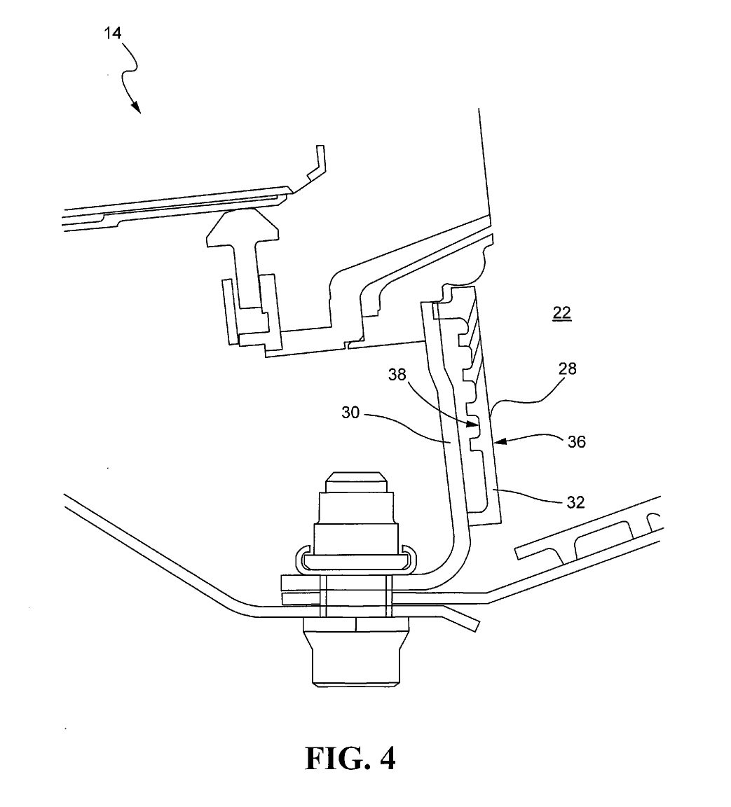

Turning now to FIGS. 4 & 5, each panel 32 of the heat shield 28 may comprise a body 34 having a front surface 36 and an opposite back surface 38 facing the shell 30. To provide cooling for the heat shield 28, the shell 30 may have a plurality of impingement holes (not shown) through which air flow passes and impinges on the back surface 38 of the heat shield 28. The body 34 of the panel 32 may further include a radially inner edge 40, a radially outer edge 42, and two lateral edges 44 which abut circumferentially adjacent heat shield panels. A fuel nozzle opening 46 to accommodate a fuel nozzle 48 (FIG. 2) may be centrally located on the body 34 of each panel 32 and may communicate through the front and back surfaces 36, 38.

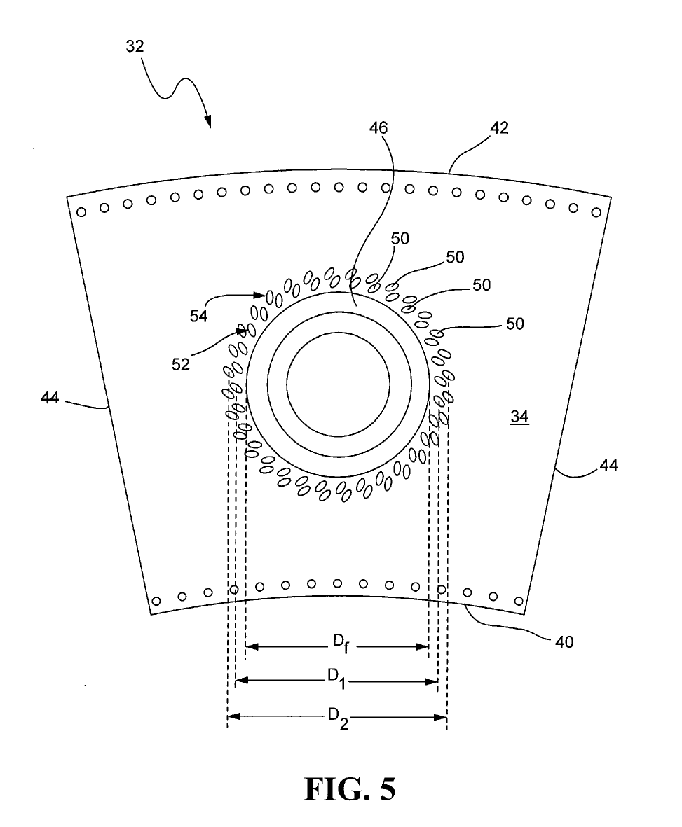

Each panel 32 may further comprise a plurality of effusion holes 50 to provide discharge of the impingement flow from the back surface 38 to the front surface 36 of the panel 32 and into the combustion chamber 22, thereby creating a film of cooling air over the front surface 36 of the panel 32. Each effusion hole 50 may have a diameter between an inclusive range of about 0.02 inches to 0.03 inches, although other dimensions are possible. The effusion holes 50 may be disposed in rows that surround and are generally concentric to the fuel nozzle opening 46, such as one, two, three, or more rows of effusion holes 50 around the fuel nozzle opening 46. For example, as shown in FIG. 5, a first row 52 of effusion holes 50 may surround and be near the fuel nozzle opening 46, and a second row 54 of effusion holes 50 may surround and be near the first row 52. The first row 52 and the second row 54 may be generally concentric to the fuel nozzle opening 46. Each row 52, 54 may have a diameter D₁, D₂, respectively, greater than the diameter Df of the fuel nozzle opening 46. The diameters D₁, D₂, of the rows 52, 54 may also be less than and including the diameter Df of the fuel nozzle opening 46 plus about 1.5 inches (Df+1.5). Other dimensions are possible. By placing the rows 52, 54 near the fuel nozzle opening 46, damage to the panel 32 can be greatly reduced.

The first and second rows 52, 54 may have a same number of effusion holes 50 disposed in each row. It is certainly possible that the first and second rows 52, 54 have a different number of effusion holes 50 disposed in each row, as well. For example, each row 52, 54 may have including and between eight (8) to forty-eight (48) effusion holes 50. The effusion holes 50 may be equally spaced apart within each row around its circumference. The effusion holes 50 of the second row 54 may be staggered with, or circumferentially offset, from the effusion holes 50 of the first row 52. In so doing, the effusion holes 50 of the second row 54 may provide cooling flow to areas around the fuel nozzle opening 46 that the first row 52 of effusion holes 50 do not cover due to the space between each of the effusion holes 50 in the row 52. As a result of the staggered arrangement between the effusion holes 50 in the first and second rows 52, 54, circumferentially uniform cooling around the fuel nozzle opening 46 on the panel 32 can be achieved. In addition, the panel 32 may have a plurality of effusion holes 50 near the radially inner edge 40 and the radially outer edge 42 to provide cooling to the inner and outer edges 40, 42.

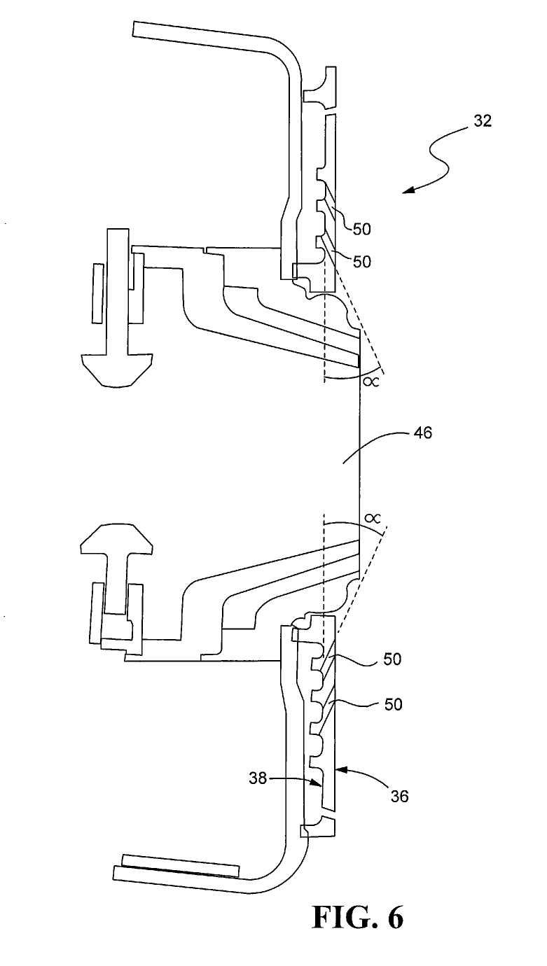

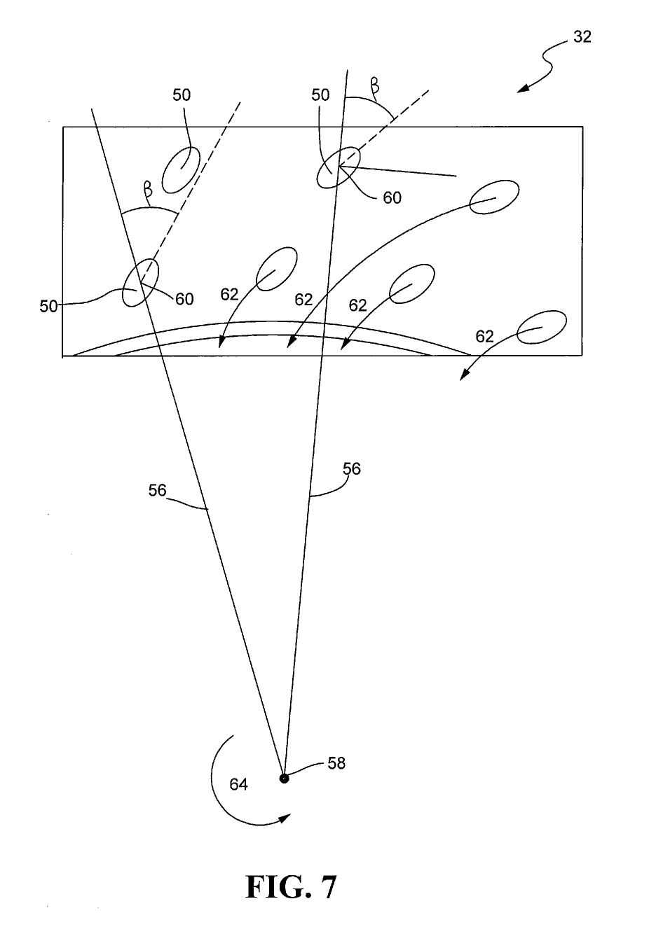

Turning now to FIG. 6, each effusion hole 50 may extend from the back surface 38 to the front surface 36 at an incline or first angle α (also termed the plunge angle). The incline angle α that the effusion hole 50 makes with the back surface 38 may be a shallow angle between the inclusive range of twenty degrees (20°) to thirty-five degrees (35°), such as a twenty-five degree (25°) angle, although other angles are certainly possible. Referring now to FIG. 7, each effusion hole 50 may also be positioned at a clock angle β from a reference line 56. The reference line 56 may start from a center 58 of the fuel nozzle opening 46 and extend through a center 60 of the effusion hole 50. The effusion hole 50 may be rotated about its central axis, forming the clock angle β with the reference line 56. The clock angle β that the effusion hole 50 makes with respect to the reference line 56 may be between an inclusive range of thirty degrees (30°) to sixty degrees (60°), such as a forty-five degree (45°) angle, although other angles are certainly possible. The clock angle β may orient the flow from the effusion hole 50.

A fuel nozzle flow has two flow components, one being a downstream (or axial) component and the other being a swirling (or circumferential) component. The incline angle α of each effusion hole 50 may, at least in part, be aligned with the downstream component of the fuel nozzle flow. The clock angle β of each effusion hole 50 may, at least in part, be aligned with the swirling component of the fuel nozzle flow. In so doing, the effusion holes 50 may impart cooling air flow to enhance the fuel nozzle swirling. For example, as shown in FIG. 7, the clock angle β of the effusion holes 50 may orient the effusion hole flow, referenced by arrows 62, in a radially inward, counter-clockwise direction, which may be the same direction as the fuel nozzle flow, referenced by arrow 64.

It will be understood that other arrangements, dimensions, and ranges for the bulkhead panel features described above are certainly possible, and that the present invention is not limited to such specific numbers.

### INDUSTRIAL APPLICABILITY

From the foregoing, it can be seen that the teachings of this disclosure can find industrial application in any number of different situations, including but not limited to, gas turbine engines. Such engines may be used, for example, on aircraft for generating thrust, or in land, marine, or aircraft applications for generating power.

The disclosure described provides an effective cooling array for the bulkhead of a gas turbine engine combustor. By providing multiple rows of effusion holes around the fuel nozzle opening, damage to the bulkhead heat shield panel is reduced and the durability and part life of the bulkhead is improved. By staggering the effusion holes between the rows, circumferential uniform cooling can be achieved. In addition, the clock angles of the effusion holes provide for co-swirling in the same direction as the fuel nozzle, thereby strengthening the film of cooling air over the surface of the heat shield panel that is exposed to extremely hot temperatures in the combustion chamber. Furthermore, the various bulkhead panel features disclosed herein result in bulkhead temperatures being reduced by several hundred degrees with no negative impact to low power emissions, operability, performance or efficiency.

While the foregoing detailed description has been given and provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims appended hereto.

What is claimed is:

1. A bulkhead panel comprising:
a body having a front surface and an opposite back surface;
a fuel nozzle opening in the body and communicating through the front and back surfaces; and
a plurality of effusion holes in the body that are disposed in at least one row that surrounds and is generally concentric to the fuel nozzle opening, each effusion hole extending from the back surface to the front surface at an incline angle and positioned at a clock angle from a reference line radially extending from a center of the fuel nozzle opening through a center of the effusion hole.

2. The bulkhead panel of claim 1, wherein the clock angle is at least in part aligned with a swirling component of a fuel nozzle flow.

3. The bulkhead panel of claim 1, wherein the incline angle is at least in part aligned with a downstream component of a fuel nozzle flow.

4. The bulkhead panel of claim 1, wherein the at least one row comprises a first row surrounding the fuel nozzle opening and a second row surrounding the first row.

5. The bulkhead panel of claim 4, wherein the first and second rows have a same number of effusion holes, the effusion holes are equally spaced apart within each respective row, and wherein the effusion holes of the second row are circumferentially offset from the effusion holes of the first row.

6. The bulkhead panel of claim 1, wherein the incline angle is between an inclusive range of 20 to 35 degrees from the back surface to the front surface.

7. The bulkhead panel of claim 1, wherein the incline angle is 25 degrees from the back surface to the front surface.

8. The bulkhead panel of claim 1, wherein the clock angle is between an inclusive range of 30 to 60 degrees from the reference line.

9. The bulkhead panel of claim 1, wherein the clock angle is 45 degrees from the reference line.

10. The bulkhead panel of claim 1, wherein each effusion hole has a diameter between an inclusive range of 0.02 to 0.03 inches.

11. The bulkhead panel of claim 1, wherein the at least one row has a diameter between a range having a lower limit of a fuel nozzle opening diameter (Df) and an inclusive upper limit of the fuel nozzle opening diameter plus 1.5 inches (Df+1.5 inches).

12. The bulkhead panel of claim 1, wherein the at least one row has a number of effusion holes between an inclusive range of 8 to 48 effusion holes.

13. A gas turbine engine comprising:
a compressor section;
a turbine section; and
a combustor, the combustor having an inner liner and an outer liner defining a combustion chamber, and a bulkhead heat shield at one end of the combustion chamber, the bulkhead heat shield having a plurality of panels, each panel having a body having a front surface and an opposite back surface, a fuel nozzle opening in the body and communicating through the front and back surfaces, and at least one row of effusion holes that surrounds and is generally concentric to the fuel nozzle opening, each of the effusion holes extending from the back surface to the front surface at an incline angle and positioned at a clock angle from a reference line radially extending from a center of the fuel nozzle opening through a center of the effusion hole.

14. The gas turbine engine of claim 13, wherein the at least one row of effusion holes comprises a first row surrounding the fuel nozzle opening and a second row surrounding the first row.

15. The gas turbine engine of claim 14, wherein the first and second rows have a same number of effusion holes, the effusion holes are equally spaced apart within each respective row, and wherein the effusion holes of the second row are circumferentially offset from the effusion holes of the first row.

16. The gas turbine engine of claim 13, wherein the clock angle is at least in part aligned with a swirling component of a fuel nozzle flow.

17. The gas turbine engine of claim 13, wherein the incline angle is at least in part aligned with a downstream component of a fuel nozzle flow.

18. A combustor for a gas turbine engine, comprising:
an inner liner and an outer liner defining a combustion chamber; and
a bulkhead heat shield at one end of the combustion chamber, the bulkhead heat shield having a plurality of panels, each panel having a having a body having a front surface and an opposite back surface, a fuel nozzle opening in the body and communicating through the front and back surfaces, and at least one row of effusion holes that surrounds and is generally concentric to the fuel nozzle opening, each of the effusion holes extending from the back surface to the front surface at a first angle, each effusion hole positioned at a clock angle from a reference line radially extending from a center of the fuel nozzle opening through a center of the effusion hole.

19. The combustor of claim 18, wherein the at least one row of effusion holes comprises a first row of effusion holes surrounding the fuel nozzle opening and a second row of effusion holes surrounding the first row, the first and second rows having a same number effusion holes equally spaced apart within each respective row, and wherein the effusion holes of the second row are circumferentially offset from the effusion holes of the first row.

20. The combustor of claim 18, wherein the clock angle orients a flow out of the effusion hole in a radially inward direction.
